(19) United States
(12) Patent Application Publication
(10) Pub. No.: US 2022/0146283 A1
(43) Pub. Date: May 12, 2022

(54) MONITORING DEVICE OF WATER METER

(71) Applicant: DAS Technology Co., Ltd., Taipei City (TW)

(72) Inventor: Tuan Hui Wu, Taipei City (TW)

(21) Appl. No.: 17/470,889

(22) Filed: Sep. 9, 2021

(30) Foreign Application Priority Data
Nov. 12, 2020 (TW) 109214956

(51) Int. Cl. G01D 4/00; G01F 15/06

(52) U.S. Cl. CPC G01D 4/008; G01F 15/063

(57) ABSTRACT

Disclosed is a monitoring device of water meter, comprising a body, a sensor, a camera module, a communication module and a microcontroller unit. The sensor, the camera module, the communication module and the microcontroller unit are disposed in the body. The sensor is used to obtain pointer rotation times information. The camera module is used to obtain reading image information. The microcontroller unit transmits the received pointer rotation times information and the reading image information to a communication module of another monitoring device of water meter and/or a server via the communication module. The monitoring device of water meter of the present invention has functions of pointer rotational detection and number display wheel image capturing, degree of water consumption is further calculated by means of the above two functions which are complementary to each other.

### TECHNICAL FIELD

The present invention relates to a monitoring device of water meter, in particular to a monitoring device of water meter with functions of pointer rotating detection and number display wheel image capturing.

### BACKGROUND

A general mechanical water meter comprises a housing, a metering device and a display unit. Two ends of the housing are respectively connected with a water inlet pipe and a water outlet pipe. The metering device is disposed in the housing for metering a volume of water passing through the housing. The display unit is disposed on the housing and comprises a number display wheel, a pointer and a metal sheet. The number display wheel is connected with the metering device, driven by the metering device to rotate, and used for displaying the accumulated degree of water consumption. The pointer is connected with the metering device and driven by the metering device to rotate. The metal sheet is mounted on the pointer and rotates along with the pointer.

The known monitoring device of water meter is mounted on the housing, and senses rotation times of the metal sheet through magnetic induction so as to indirectly obtain the rotation times of the pointer to further obtain pointer rotation times information, and then the pointer rotation times information is transmitted to a concentrator. The concentrator further transmits the pointer rotation times information to a server. A water meter data management unit of the server can calculate a degree of water consumption in accordance with the pointer rotation times information and judge that the pointer rotates forward or reversely or continuously within a unit time. Forward rotation of the pointer represents normal use. Reverse rotation of the pointer represents that the water meter is inverted by a user so as to steal water. Continuous rotation of the pointer within a unit time represents water leakage of a water pipe.

However, as rotation of the pointer may be influenced by site humidity, thunder strike or artificial magnetic interference, asynchronized rotation of the pointer and the metering device is caused, thus, the problem can occur that rotation times may be excess-calculated or short-calculated, and an error is then produced in calculating the degree of water consumption, so that a water fee may be overcharged or undercharged.

In order to resolve the above problems, another monitoring device of water meter emerges in the market. This monitoring device of water meter comprises a camera module for capturing an image of a number display wheel of a water meter to obtain a reading image information, and then the reading image information is transmitted to a concentrator. The concentrator further transmits the reading image information to a server, and an image identifying unit of the server can calculate a degree of water consumption in accordance with the reading image information. As the image of the number display wheel captured by the camera module is not influenced by site humidity, thunder strike or artificial magnetic interference, the calculated degree of water consumption is high in accuracy, and the problem of excess-calculated or short-calculated rotation times is solved.

However, each camera shooting of the camera module consumes a time of 10 s and a current of 20-30 mA, so that power consumption is high. If this monitoring device of water meter is to sense that the pointer rotates forward or reversely or continuously within a unit time, the camera module has to perform continuous camera shooting, in such case, the image identifying unit can determine that the pointer rotates forward or reversely or continuously within a unit time in accordance with the continuously captured images of the number display wheel. It should be noted that continuous camera shooting is so electricity-consuming that a battery may run out quickly. As such, a running-water company needs to frequently appoint staff to replace a battery for a user, and otherwise, once the battery runs out, the monitoring device of water meter fails to operate. At this rate, human and battery costs are extremely high. Hence, in order to save human and battery costs, this monitoring device of water meter is generally limited to perform camera shooting once per day to calculate a degree of water consumption of a single day. Since the monitoring device of water meter is not allowed to perform continuous camera shooting, it is unable to monitor that the pointer rotates forward or reversely or continuously within a unit time , and thus the running-water company is unable to know whether water steeling of users or water pipe leakage exists.

Furthermore, if it rains, the surface of the display unit of the water meter is likely to be fogged, so that the image of the number display wheel captured by the camera module is so unclear that the image identifying unit is unable to identify the image of the number display wheel and thus the degree of water consumption can not be calculated.

But even in a sunny day, sometimes when the number display wheel just rotates halfway and an image thereof is captured at this time, so that the image identifying unit cannot identify the digit of the number display wheel.

The above two monitoring device of water meters need to be respectively matched with a concentrator, but the concentrator suffers from the following defects.

Firstly, the concentrator has a huge size and thus cannot be fixed on a water meter due to requiring installing of an operation system. In order to resolve this problem, the running-water company generally needs to consult with a user to fix a concentrator on a wall of the user's house. However, if some users are not willing to fix a concentrator on their walls, which troubles the running-water company and the users a lot.

Secondly, the operation system of the concentrator consumes a lot of power, and a common battery is incapable of supplying sufficient power to ensure normal operation of the concentrator. In order to resolve this problem, the running-water company often needs to consult with a user about borrowing of mains supply so as to provide enough power for ensuring normal operation of the concentrator. However, it is easy to cause disputes on electricity fee with the users if doing so, which troubles the running-water company and users a lot, too.

Thirdly, owing to high cost of a general concentrator, one concentrator can collect information of hundreds or even thousands of water meters so as to reduce the quantity of concentrators in each area, thereby lowering cost in installation of the concentrators and being suitable for an area with low density of buildings. However, in an area with high density of buildings, water meters are usually distributed on each floor and underfloor, and wireless radio frequency signals are easily interfered by buildings, therefore, the effect of the pointer rotation times information or the reading image information collected by each concentrator is less than 50%.

Fourthly, the wireless radio frequency units of the above two monitoring device of water meters make use of automatic networking, and a plurality of wireless radio frequency units of monitoring device of water meters of a plurality of water meters are connected to each other automatically and randomly. For example, the wireless radio frequency unit of a monitoring device of water meter on the first floor is automatically connected with that on the fiftieth floor, rather than that on the second floor, and so on. This automatic and random on-line mode is too complex and low in efficiency, wireless radio frequency signals are easily unstable due to interference from buildings, so that this kind of monitoring device of water meter is not suitable for an area with high density of buildings.

### SUMMARY

The main object of the present invention is to provide a monitoring device of water meter with functions of pointer rotating detection and number display wheel image capturing. By use of at least one of the above two functions, the degree of water consumption is further calculated. These two functions are complementary to each other.

Another object of the present invention is to provide a monitoring device of water meter. A microcontroller unit has the function of a concentrator but does not need to install an operation system, so that the microcontroller unit is small in size and can be disposed in a body. In addition, two modes, i.e., a standby mode and a turn-on mode are provided, and as the microcontroller unit consumes less power, the service life of a battery is prolonged and enough power is provided for continuous camera shooting.

Besides, the monitoring device of water meter of the present invention controls, by means of the manual networking mode, a transmission path of wireless radio frequency signals of a wireless radio frequency unit to reduce interference from buildings.

Also, the monitoring device of water meter of the present invention is capable of eliminating mist on the surface of th display unit, so that the surface of the display unit is clear, and it is ensured that the captured image of the number display wheel is clear.

In order to realize the above objects, the present invention provides a monitoring device of water meter, comprising: a body, a sensor, a camera module, a communication module and a microcontroller unit.

The body can be mounted on a water meter.

The sensor is disposed in the body and used for sensing rotation times of a metal sheet of the water meter so as to indirectly obtain the rotation times of a pointer of the water meter to further obtain pointer rotation times information.

The camera module is disposed in the body and used for capturing an image of a number display wheel of the water meter so as to obtain reading image information.

The communication module is disposed in the body and used for being connecting with a communication module of another monitoring device of water meter and/or a server.

The microcontroller unit is disposed in the body and electrically connected with the sensor, the camera module and the communication module. The sensor transmits the pointer rotation times information to the microcontroller unit, the camera module transmits the reading image information to the microcontroller unit, the microcontroller unit transmits the received pointer rotation times information and the reading image information to the communication module, the communication module transmits the received pointer rotation times information and the reading image information both containing an identifier to the communication module of another monitoring device of water meter and/or the server, the server comprises a water meter data management unit for calculating a degree of water consumption in accordance with the pointer rotation times information and an image identifying unit for calculating a degree of water consumption in accordance with the reading image information, and the server selects at least one of the pointer rotation times information and the reading image information as a basis for calculating a degree of water consumption of each water meter.

### BRIEF DESCRIPTION OF THE DRAWINGS

FIG. 1 is a perspective view of a first embodiment of the present invention;

FIG. 2 is an exploded view of the first embodiment of the present invention;

FIG. 3 is a top view of a body of the first embodiment of the present invention;

FIG. 4 is a structural block diagram of the first embodiment of the present invention;

FIG. 5 is a perspective view of the first embodiment of the present invention mounted on a water meter;

FIG. 6 is an exploded view of the first embodiment of the present invention mounted on the water meter;

FIG. 7 is a block diagram of sensing rotation times of a metal sheet by the first embodiment of the present invention;

FIG. 8 is a schematic diagram of camera shooting of the first embodiment of the present invention;

FIG. 9 is a block diagram of camera shooting of the first embodiment of the present invention;

FIG. 10 is a perspective view of a housing of the first embodiment of the present invention at an open position;

FIG. 11 is a schematic diagram of a plurality of first embodiments of the present invention disposed on different floors of a building;

FIG. 12 is a perspective view of a second embodiment of the present invention;

FIG. 13 is an exploded view of the second embodiment of the present invention;

FIG. 14 is a perspective view of the second embodiment of the present invention mounted on a water meter;

FIG. 15 is an exploded view of the second embodiment of the present invention mounted on the water meter.

### DETAILED DESCRIPTION OF THE EMBODIMENTS

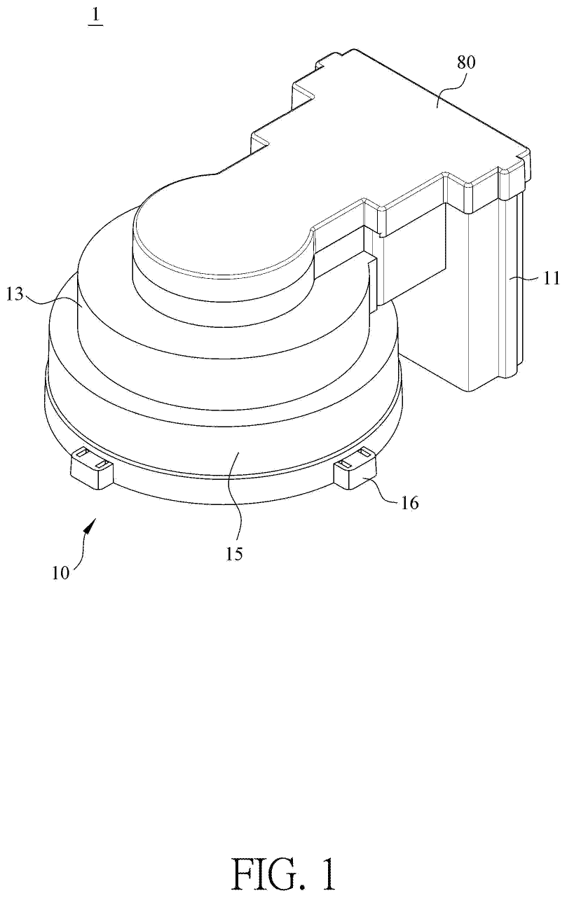

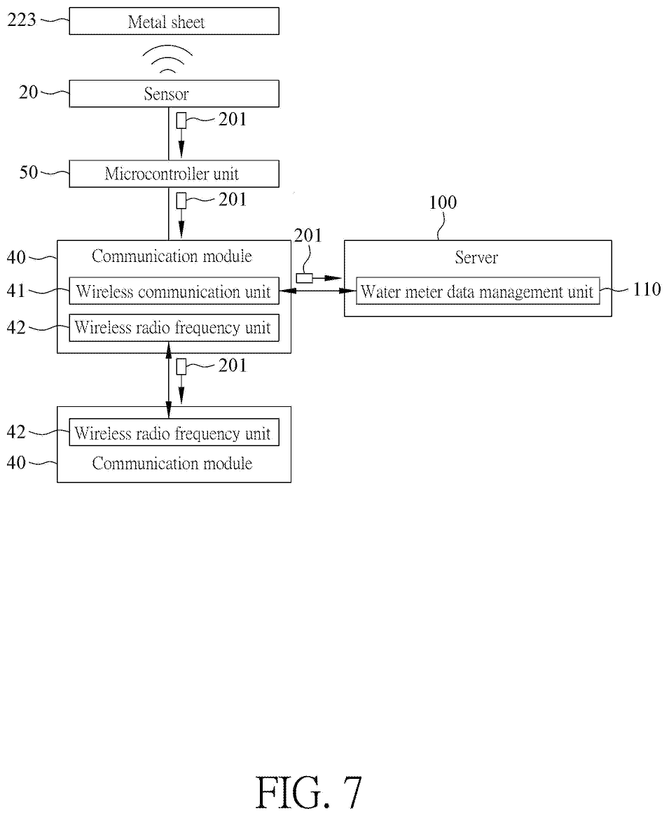

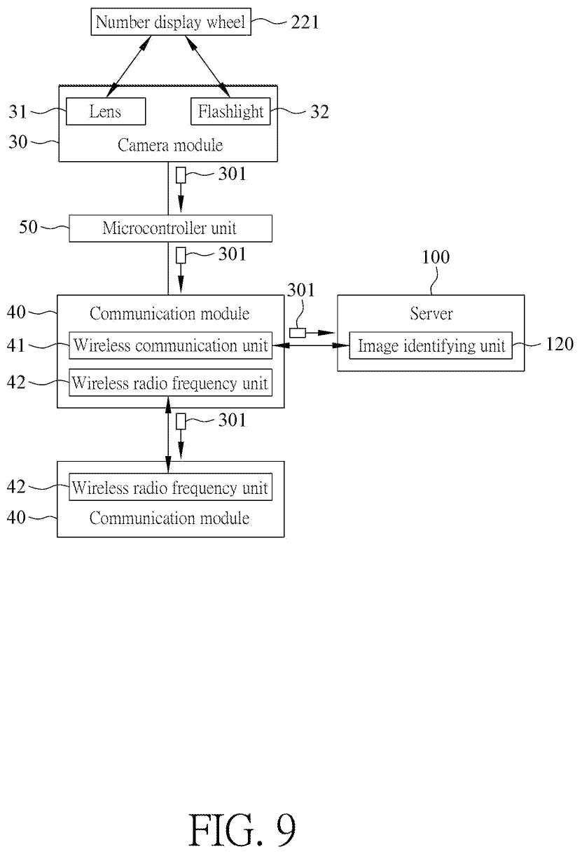

Please refer to FIGS. 1 to 4, which show a perspective view, an exploded view, a top view of a body and a structural block diagram of a first embodiment of the present invention respectively. As shown in FIGS. 1 to 4, the present invention provides a monitoring device of water meter 1, comprising: a body 10, a sensor 20, a camera module 30, a communication module 40 and a microcontroller unit (MCU) 50. The sensor 20, the camera module 30, the communication module 40 and the microcontroller unit 50 are disposed in the body 10. The microcontroller unit 50 is electrically connected with the sensor 20, the camera module 30 and the communication module 40. The communication module 40 is used for connecting with a communication module 40 of another monitoring device of water meter 1 and/or a server 100 (see FIGS. 7 and 9).

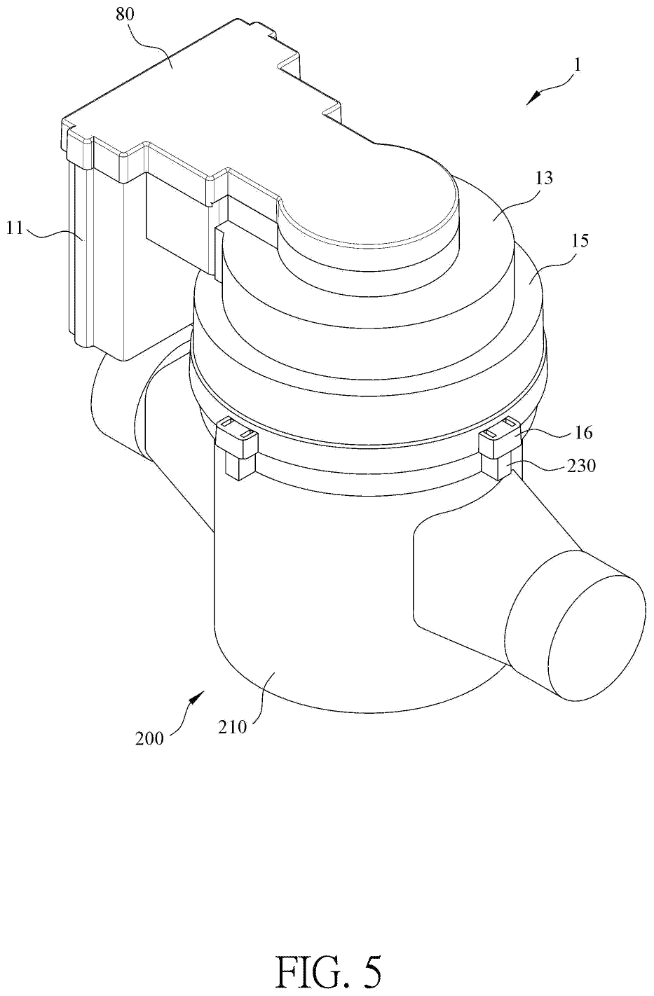

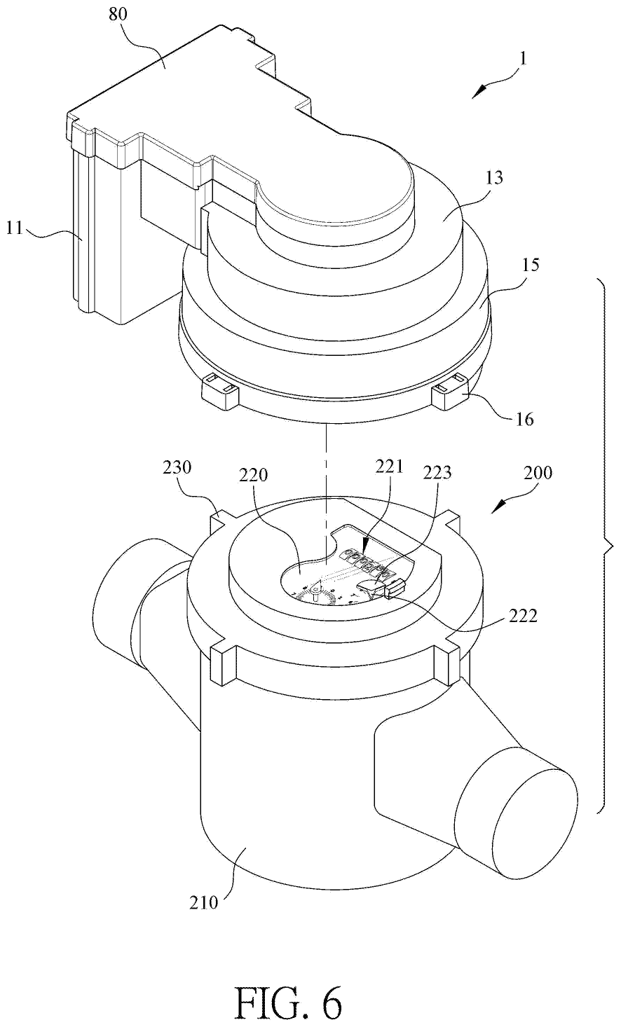

Please refer to FIGS. 5 and 6, which show a perspective view and an exploded view of the first embodiment of the present invention mounted on a water meter 200 respectively. As shown in FIGS. 5 and 6, the water meter 200 comprises a housing 210, a metering device (not shown) and a display unit 220. Two ends of the housing 210 are respectively connected with a water inlet pipe (not shown) and a water outlet pipe (not shown). The metering device is disposed in the housing 210 for metering a volume of water passing through the housing 210. The display unit 220 is disposed on the housing 210 and comprises a number display wheel 221, a pointer 222 and a metal sheet 223. The number display wheel 221 is connected with the metering device, driven by the metering device to rotate, and used for displaying an accumulated degree of water consumption. The pointer 222 is connected with the metering device and driven by the metering device to rotate. The metal sheet 223 is disposed on the pointer 222 and rotates along with the pointer 222. The body 10 is mounted on the housing 210. Please refer to FIG. 7, FIG. 7 shows a block diagram of sensing rotation times of the metal sheet 223 by the first embodiment of the present invention. As shown in FIG. 7, the sensor 20 senses the rotation times of the metal sheet 223 through magnetic induction so as to indirectly obtain the rotation times of the pointer 222 so as to further obtain pointer rotation times information 201, and the pointer rotation times information 201 is transmitted to the microcontroller unit 50 by the sensor 20. The microcontroller unit 50 further transmits the received pointer rotation times information 201 to the communication module 40. The communication module 40 transmits the received pointer rotation times information 201 to the server 100. A water meter data management unit 110 of the server 100 calculates a degree of water consumption in accordance with the pointer rotation times information 201 and determines that the pointer 222 rotates forward or reversely or continuously within a unit time. That is to say, when the metal sheet 223 rotates along with the pointer 222, a current density sensed by the sensor 20 is in relation to the distance between the metal sheet 223 and the sensor 20, so as to calculate forward or reverse rotation. Forward rotation of the pointer 222 represents normal use, and reverse rotation of the pointer 222 represents that the water meter 200 is inverted by a user to steal water. Besides, it generally takes 1-2 min in normal water use, such as brushing teeth, washing face, washing fruits or dishes, even pouring water into a bathtub lasts for at most 10 min, and it is impossible to use water for a continuous long period of time. Therefore, it is feasible to make such a setting that continuous rotation (e.g., continuous rotation for over 30 min) of the pointer 222 within a unit time represents water leakage of a water pipe.

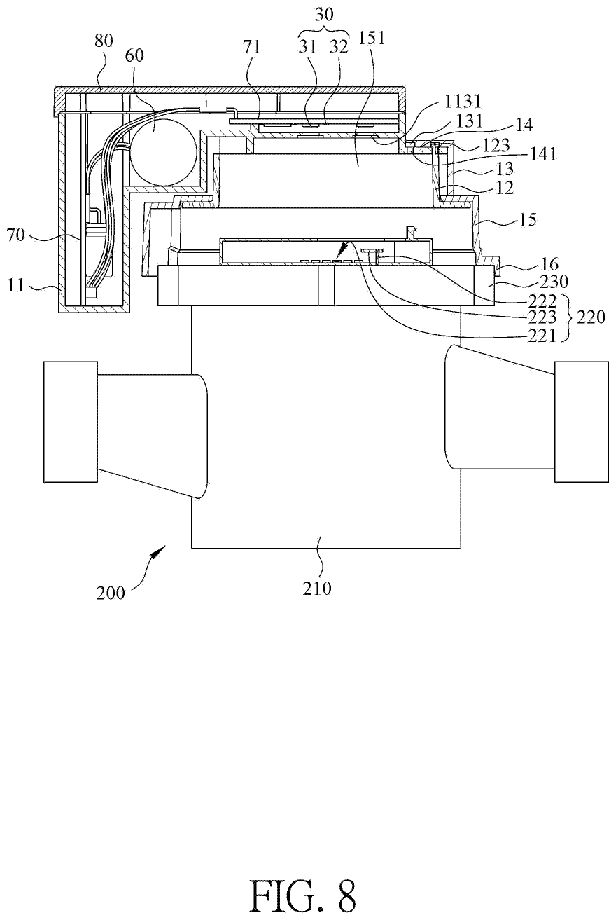

Please refer to FIGS. 8 and 9, which show a schematic diagram and a block diagram of camera shooting of the first embodiment of the present invention respectively. As shown in FIGS. 8 and 9, the camera module 30 is used for capturing an image of a number display wheel 221 so as to obtain reading image information 301; the camera module 30 transmits the reading image information 301 to the microcontroller unit 50, the microcontroller unit 50 transmits the received reading image information 301 to the communication module 40, and the communication module 40 transmits the received reading image information 301 to the server 100. An image identifying unit 120 of the server 100 calculates a degree of water consumption in accordance with the reading image information 301. Therefore, the monitoring device of water meter 1 of the present invention has functions of pointer rotating detection and number display wheel image capturing, and the degree of water consumption is further calculated by at least one of the above two functions.

Besides, if the rotation of the pointer 222 is influenced by factors such as site humidity, thunder strike, or artificial magnetic interference, asynchronized rotation of the pointer 222 and the metering device is caused, and then an error is produced between the pointer rotation times information 201 sensed by the sensor 20 and the actual pointer rotation times information. In contrast, as the image of the number display wheel 221 is not influenced by factors such as site humidity, thunder strike or artificial magnet interference, the image identifying unit 120 of the server 100 can calculate the degree of water consumption in accordance with the reading image information 301, so that the accuracy is high, and the disadvantage of the sensor 20 is made up.

Further, if the surface of the housing 210 is fogged, the digit of the number display wheel 221 rotates halfway or the like, so that the image of the number display wheel 221 is unclear, and thus the camera module 30 cannot obtain a clear reading image information 301, at this time, the water meter data management unit 110 of the server 100 can calculate the degree of water consumption in accordance with the pointer rotation times information 201 and determine that the pointer 222 rotates forward or reversely or continuously within a unit time, thus making up the disadvantage of the camera module 30.

Also, if the water meter data management unit 110 of the server 100 determines that the pointer 222 rotates forward or reversely or continuously within a unit time in accordance with the pointer rotation times information 201, the image identifying unit 120 of the server 100 will automatically calculate the degree of water consumption in accordance with the reading image information 301.

After the server 100 calculates the degree of water consumption in accordance with the pointer rotation times information 201 and the reading image information 301, the server 100 compares the pointer rotation times information 201 and the reading image information 301 of each water meter, and if the error between the degree of water consumption calculated in accordance with the pointer rotation times information 201 and that calculated in accordance with the reading image information 301 of each water meter is greater than 1%, the server 100 transmits a warning signal to a manager (e.g., the running-water company) of the server 100 through 4G, NB-IOT or Ethernet, and the running-water company will artificially calculate the degree of water consumption in accordance with the reading image information 301.

The monitoring device of water meter 1 of the present invention makes use of a microcontroller unit 50 with functions of a concentrator with no need to install an operation system, so as to receive the pointer rotation times information 201 and the reading image information 301, and the microcontroller unit 50 features small size, low power consumption and low manufacture cost, and can be mounted in the body 10 with no need to borrow a wall from a user.

It is worth mentioning that the monitoring device of water meter 1 of the present invention can be mounted on a mechanical water meter 200. Besides low failure rate of the mechanical water meter 200, the monitoring device of water meter 1 of the present invention can also provide functions of pointer rotation times detection and reading image capturing of an electric water meter. Therefore, the monitoring device of water meter of the present invention is novel and practical.

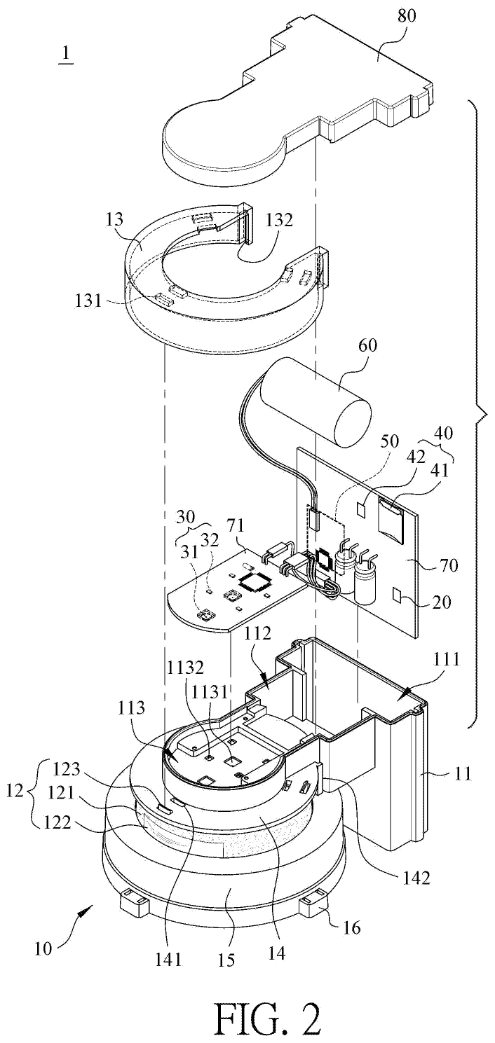

As shown in FIGS. 2 to 4, the monitoring device of water meter 1 further comprises a battery 60, the battery 60 disposed in the body 10 and electrically connected with the microcontroller unit 50. The battery 60 directly supplies power to the microcontroller unit 50 and supplies power to the sensor 20, the camera module 30 and the communication module 40 through the microcontroller unit 50. The microcontroller unit 50 has a standby mode 51 and a turn-on mode 52. When the sensor 20 senses that the metal sheet 223 stops rotation, the microcontroller unit 50 receives no pointer rotation times information 201 and switches into the standby mode 51, and the microcontroller unit 50 further controls the camera module 30 and the communication module 40 to stop operation. When the sensor 20 senses that the metal sheet 223 starts rotation, the microcontroller unit 50 is immediately wakened upon receiving the pointer rotation times information 201 and switches into the turn-on mode 52, and the microcontroller unit 50 further controls the camera module 30 and the communication module 40 to start operation.

Therefore, the monitoring device of water meter 1 of the present invention enters the turn-on mode only when water passes through the housing 210 to perform the functions of pointer 222 rotating detection and number display wheel 221 image capturing; when no water passes through the housing 210, the monitoring device of water meter 1 of the present invention enters the standby mode to reduce power consumption, and in combination with the low power consumption of the microcontroller unit 50, an electricity-saving effect is achieved, so that the service life of the battery 60 is prolonged; meanwhile, borrowing mains supply from users is not required, and the running-water company does not need to assign staff to replace batteries 60 for users anymore, so that labor and battery 60 costs are saved.

Further, as the monitoring device of water meter 1 of the present invention enters the turn-on mode only when water passes through the housing 210, then the camera module 30 begins to capture the image of the number display number 221, so that the battery 60 is capable of supplying enough power to the camera module 30 for continuous camera shooting so as to provide enough reading image information 301 to the image identifying unit 120.

In other embodiments, the monitoring device of water meter 1 further comprises an electrical connection portion (not shown). The electrical connection portion is electrically connected with the microcontroller unit 50 and has a power line and a plug. The plug is plugged into mains supply, and supplies power to the microcontroller unit 50 via the power line and to the sensor 20, the camera module 30 and the communication module 40 via the microcontroller unit 50. Therefore, the monitoring device of water meter 1 of the present invention is electricity-saving, and willing of a user to lend main supplies is improved. Therefore, the monitoring device of water meter can also be connected with the main supplies via the electrical connection portion so as to obtain power required for operation.

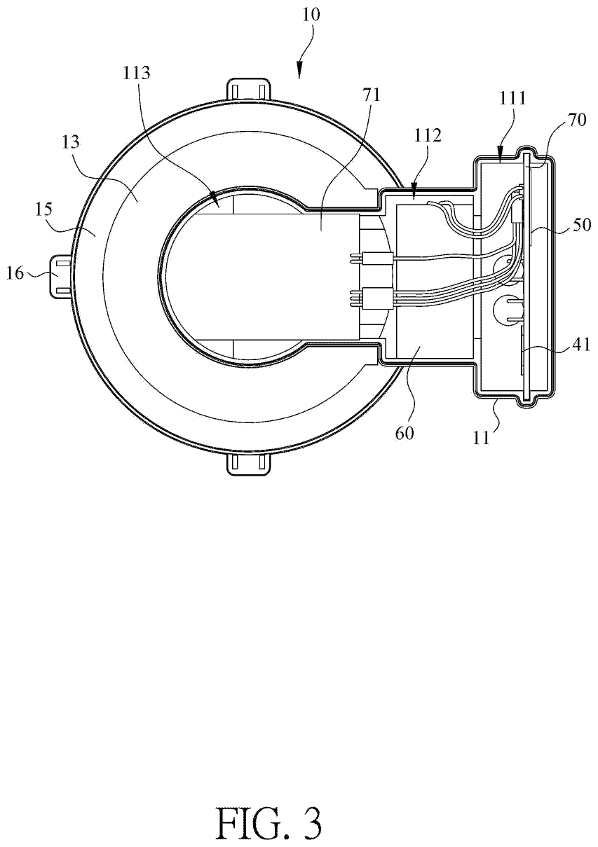

As shown in FIGS. 2 and 3, the body 10 comprises a containing portion 11, the containing portion 11 is provided with a plurality of containing slots defined as a control slot 111, a battery slot 112 and a camera slot 113 respectively. The sensor 20, the communication module 40 and the microcontroller unit 50 are integrated on a circuit board 70 and disposed in the control slot 111. The battery 60 is disposed in the battery slot 112. The camera module 30 is integrated on another circuit board 71 and disposed in the camera slot 113. As shown in FIGS. 1 and 2, the monitoring device of water meter 1 further comprises a cover body 80, the cover body covering the containing portion for closing the control slot 111, the battery slot 112 and the camera slot 113 so as to protect the sensor 20, the communication module 40, the microcontroller unit 50, the battery 60 and the camera module 30. In case of failure of the sensor 20, the communication module 40, the microcontroller unit 50, the battery 60 or the camera module 30, the failed component can be removed and replaced by a new component only by opening the cover body 80 so as to realize a maintenance effect.

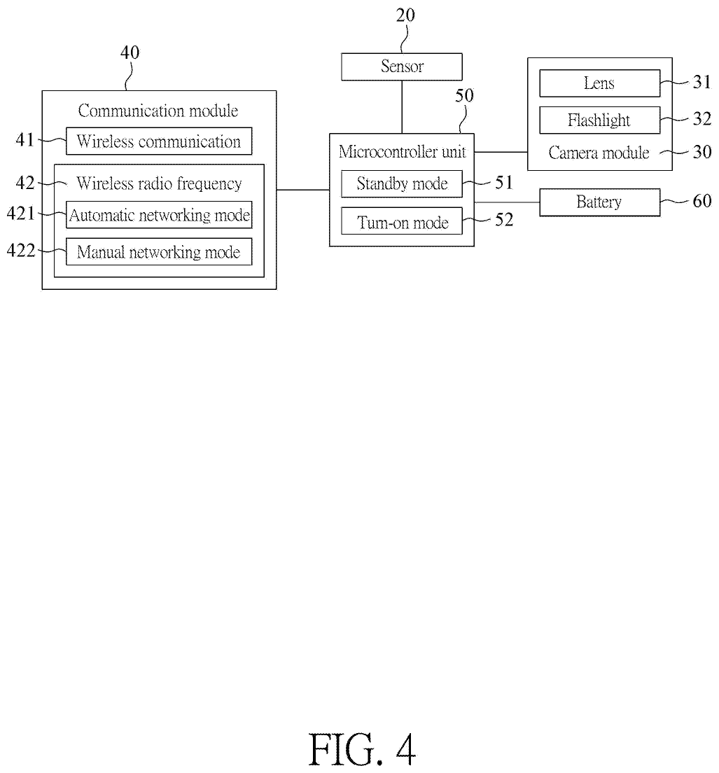

As shown in FIGS. 2 and 4, the bottom of the camera slot 113 is provided with a plurality of lens holes 1131 and a plurality of flashlight holes 1132, the camera module 30 comprises a plurality of lenses 31 and a plurality of flashlights 32, the plurality of lenses 31 face the plurality of lens holes 1131, and the plurality of flashlight holes 32 face the plurality of flashlight holes 1132. As shown in FIGS. 8 and 9, light sources of the plurality of flashlights 32 can penetrate through the plurality of flashlight holes 1132 to irradiate on the display unit 220. The plurality of lenses 31 can penetrate through the lens holes 1131 to capture the image of the number display wheel 221.

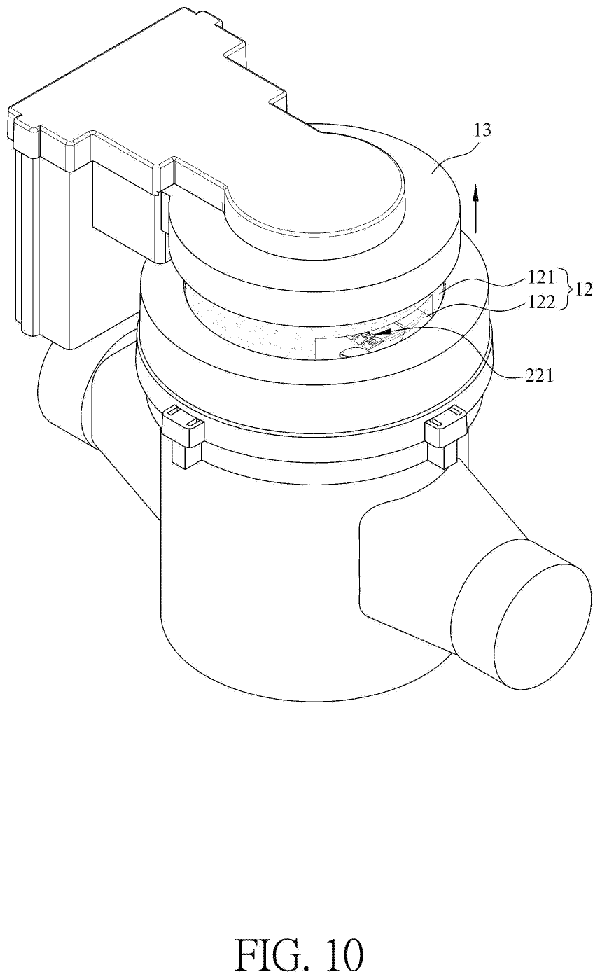

As shown in FIGS. 1 to 3, the body 10 comprises an annular wall 12 and a shield body 13. The annular wall 12 is non-opaque and has a fogged surface 121 and a transparent window 122. The shield body 13 is slidably disposed on the body 10 and movable between an open position and a closed position. As shown in FIGS. 5 and 8, when the shield body 13 is at the closed position, the shield body 13 completely shields the annular wall 12 so that outside light rays cannot penetrate through the annular wall 12 to enter inside of the body 10, thus avoiding unclear images of the number display wheel 221 captured by the plurality of lenses 31 due to light reflection caused by interference from outside light rays. As shown in FIG. 10, when the shield body 13 is at the open position, the shield body 13 does not shield the annular wall 12 so that outside light rays can penetrate through the annular wall 12 to enter inside of the body 10, a user can visually observe the number display wheel 221 through the transparent window 122 to obtain the accumulated degree of water consumption at current.

Preferably, as shown in FIGS. 1 to 3, the body 10 is provided with a fixing portion 14. The fixing portion 14 is arranged outside the camera slot 113 in an encircled manner and provided with a plurality of through slots 141. Two ends of the fixing portion respectively form two sliding rails 142. One top face of the annular wall 12 is provided with a plurality of hooking portions 123 in a protruded manner. The plurality of hooking portions 123 penetrate through the through slots 141 and hook the fixing portion 14. Two sides of the battery slot 112 are respectively provided with two sliding rails 142 in a protruded manner. The housing 13 is in a ring shape. The inner side of one top wall of the housing 13 is provided with a plurality of clamping slots 131. Two ends of the housing 13 are respectively provided with two sliding chutes 132 in a sunken manner. The two sliding rails 142 correspond to the two sliding chutes 132 so that the housing 13 is movable between the open position and the closed position relative to the annular wall 12. As shown in FIG. 8, when the housing 13 is at the closed position, the plurality of hooking portions 123 are respectively positioned in the plurality of clamping slots 131. As shown in FIG. 10, when the housing 13 is at the open position, the plurality of hooking portions 123 respectively disengage from the clamping slots 131.

As shown in FIGS. 1 to 3, the body comprises a mounting portion 15 and a plurality of clamping portions 16. The mounting portion 15 is arranged below the annular wall 12 and forms an inner space 151 with the annular wall 12. The plurality of first clamping portions 16 are arranged outside the mounting portion 15 in a protruded manner. As shown in FIG. 6, the water meter is provided with a plurality of second clamping portions 230. The plurality of second clamping portions 230 are arranged outside the housing in a protruded manner. As shown in FIG. 5, the plurality of first clamping portions 16 can be detachably clamped on the plurality of second clamping portions 230. As shown in FIGS. 8 and 9, light sources of the plurality of flashlights 32 can successively penetrate through the plurality of flashlight holes 1132 and the inner space 151 to irradiate the display unit 220. The plurality of lenses 31 can penetrate through the plurality of lens holes 1131 and the inner space 151 to capture an image of the number display wheel 221 in an environment with sufficient light sources. As shown in FIGS. 2 and 4, the communication module 40 comprises a wireless communication unit 41 and a wireless radio frequency unit 42. In other feasible embodiments, information transmission between different communication modules 40 may be changed into wired transmission. In this embodiment, the wireless communication unit 41 is connected with the server 100. The wireless communication unit 41 uses the communication mode of 4G, 5G, a long range wide area network (LoRaWAN), a narrow band interne of things (NB-IoT) or a wireless network (Wi-Fi). The wireless radio frequency unit 42 has an automatic networking mode 421 and a manual networking mode 422. As shown in FIGS. 7 and 9, when the wireless radio frequency unit 42 is set as the automatic networking mode 421, the wireless radio frequency unit 42 is automatically and randomly connected with a wireless radio frequency unit 42 of one of a plurality of monitoring device of water meters 1; and when being set as the manual networking mode 422, the wireless radio frequency unit 42 is set to be manually connected with a wireless radio frequency unit 42 of at most two monitoring device of water meters 1 closest to the wireless radio frequency unit 42.

If the water meter 200 is arranged in an area with low density of buildings, the wireless radio frequency unit 42 is suitable for being set as the automatic networking mode 421. If the water meter 200 is arranged in an area with high density of buildings, the wireless radio frequency unit 42 is suitable for being set as the manual networking mode 422.

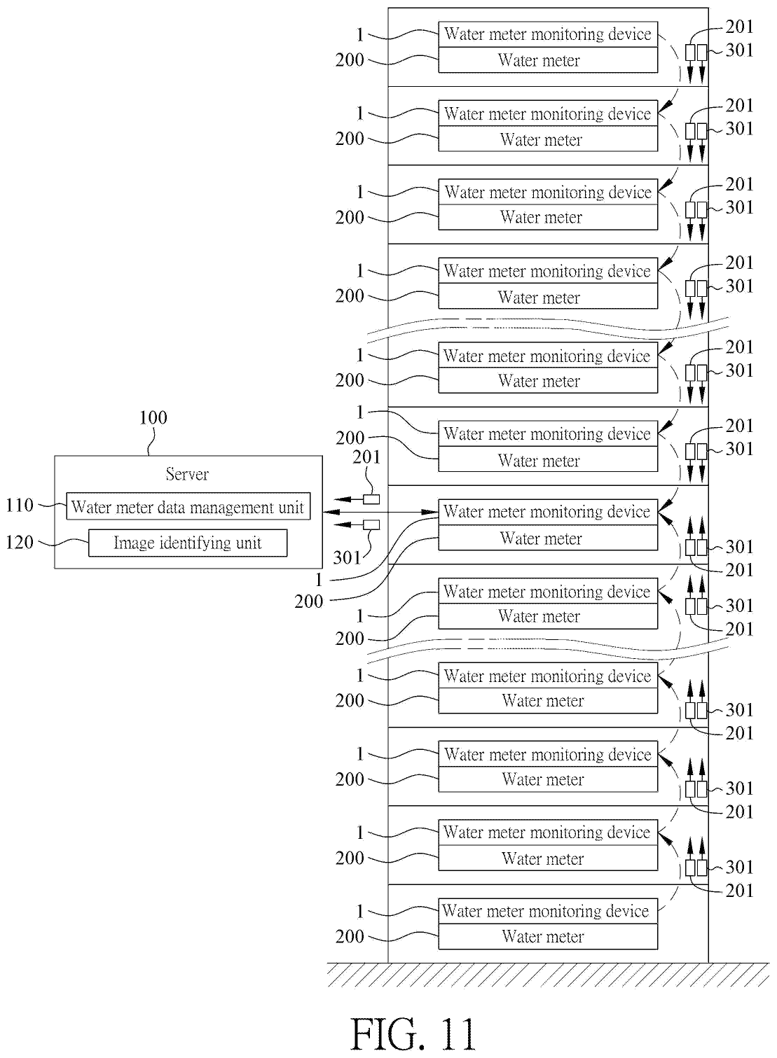

Please refer to FIG. 11, FIG. 11 shows a schematic diagram of a plurality of first embodiments of the present invention disposed on different floors of a building. The building in FIG. 11 is located in an area with high density of buildings in which wireless radio frequency signals are easily interfered by buildings, at this time, the plurality of wireless radio frequency units 42 of the plurality of monitoring device of water meters 1 are all set as the manual networking mode 422, that is to say, on-line relationships between monitoring device of water meters 1 are defined in the communication modules 40 of monitoring device of water meters 1, the pointer rotation times information 201 and the reading image information 301 measured by each monitoring device of water meter 1 respectively contain a corresponding identifier. One of the communication modules 40 is used for receiving the pointer rotation times information 201 and the reading image information 301 both containing an identifier from a communication module 40 of another monitoring device of water meter 1 so as to enable all the pointer rotation times information 201 and the reading image information 301 both containing an identifier received by the communication module 40 to be transmitted to the server 100. As shown in FIG. 11, the plurality of monitoring device of water meters 1 on a higher floor can successively transmit the pointer rotation times information 201 and the reading image information 301 of the plurality of water meters 200 on higher floors downward to a wireless radio frequency unit 42 of one of the monitoring device of water meters 1 on a middle floor by means of the wireless radio frequency units 42 thereof. The plurality of monitoring device of water meters 1 on lower floors can successively transmit the pointer rotation times information 201 and the reading image information 301 of the plurality of water meters 200 on lower floors upward to the wireless radio frequency unit 42 of one of the monitoring device of water meters 1 on a middle floor by means of the wireless radio frequency units 42 thereof. The wireless communication unit 41 of one of the monitoring device of water meters 1 on a middle floor transmits the received pointer rotation times information 201 and the reading image information 301 of all water meters 200 to the water meter data management unit 110 and the image identifying unit 120 of the server 100. The server 100 can distinguish respective pointer rotation times information 201 and reading image information 301 of each water meter 200 after identifying each identifier so as to enable the server 100 to select at least one of the pointer rotation times information 201 and the reading image information 301 of each water meter 200 as a basis for calculating a degree of water consumption of each water meter 200.

Therefore, the monitoring device of water meter 1 can control the transmission path of the wireless radio frequency signals of the plurality of wireless radio frequency units 42 by the manual networking mode, so that interference from buildings is reduced, on-line efficiency is high and stable, and the monitoring device of water meter is suitable for an area with high density of buildings.

Further, as long as the communication module 40 of one of the monitoring device of water meters 1 on a middle floor has a wireless communication unit 41, the communication modules 40 of the plurality of monitoring device of water meters 1 on other floors do not need to have wireless communication units 41, thereby reducing cost.

Also, each microcontroller unit 50 can receive about twenty pointer rotation times information 201 and reading image information 301 of each water meter 200, although it is incomparable with a common concentrator, but the microcontroller unit 50 costs far less than the concentrator. In an area with high density of buildings, the pointer rotation times information 201 and the reading image information 301 of all water meters 200 in the area can be integrated and received by a portion of monitoring device of water meters 1 only by mounting the monitoring device of water meters 1 on the water meters 200, and the entire cost is still le than that of a single concentrator.

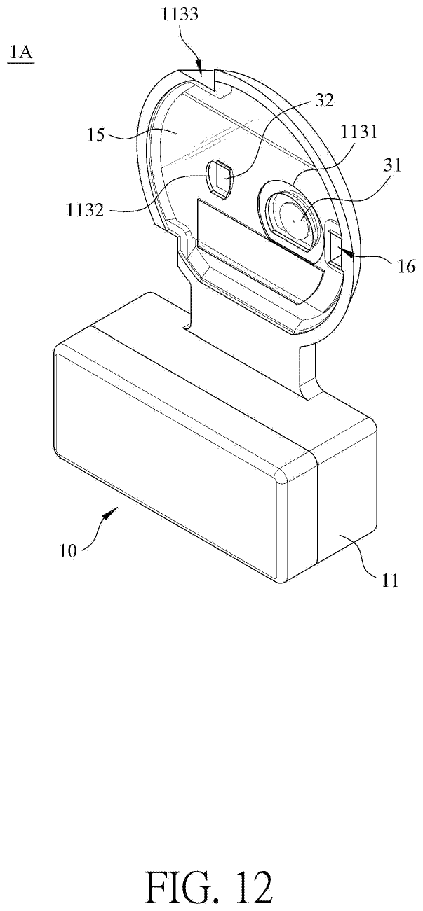

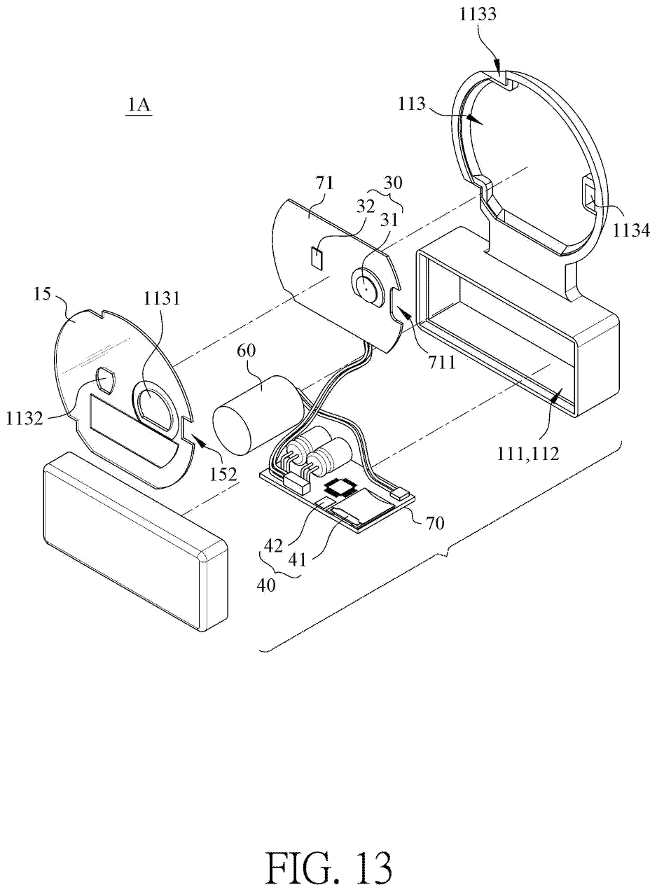

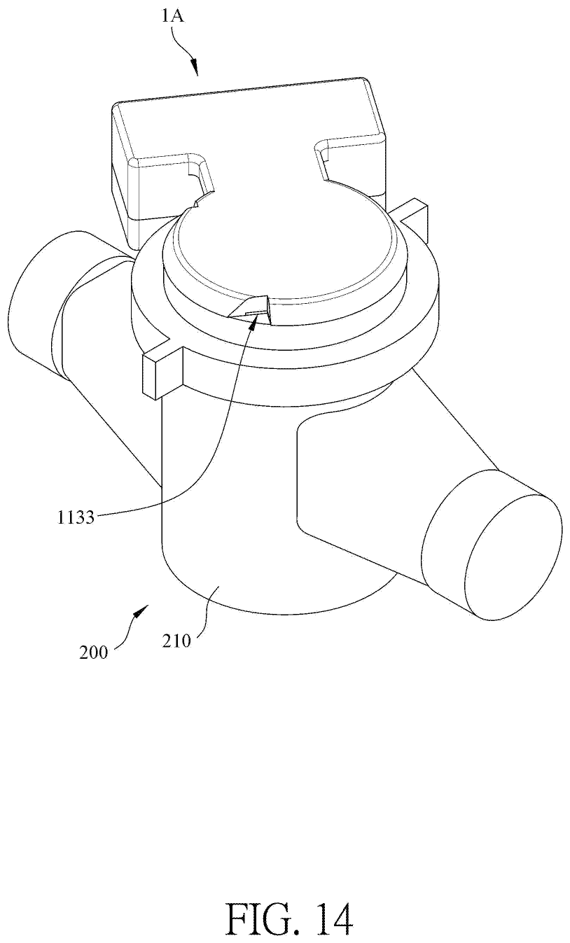

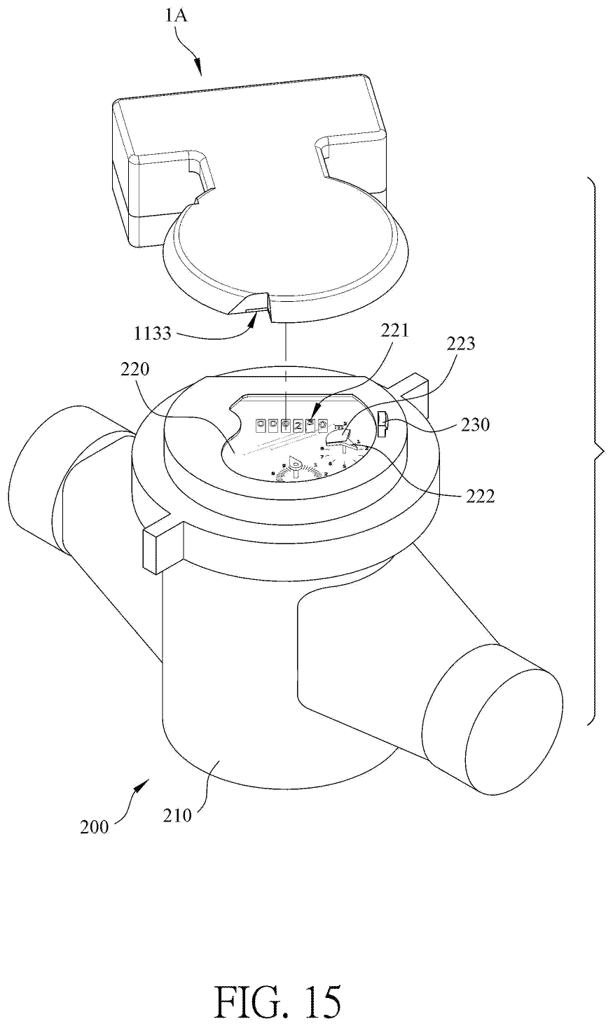

Please refer to FIGS. 12 to 15, which show a perspective view and an exploded view of a second embodiment of the present invention, as well as a perspective view and an exploded view of the second embodiment mounted on the water meter 200 respectively. The monitoring device of water meter 1A of the second embodiment differs from the monitoring device of water meter 1 of the first embodiment in that: firstly, two vents 1133 are formed outside the camera slot 113, and the vents 1133 are used for eliminating mist on the surface of the display unit 220 so that the surface of the display unit 220 becomes clear, and images of the number display wheel 221 captured by the plurality of lenses 31 are very clear; secondly, the control slot 111 and the battery slot 112 are integrated so as to reduce size; thirdly, the monitoring device of water meter does not comprise an annular wall 12, a housing 13 or a cover body 80; fourthly, the camera module 30 merely comprises a lens 31 and a flashlight 32; fifthly, the mounting portion 15 is a transparent cover and is provided with a lens hole 1131, a flashlight hole 1132 and a gap 152, a circuit board 70 forms a gap 711, the camera slot 113 is provided with a caulking groove 1134. The gaps 152, 711 and the caulking groove 1134 jointly form a first clamping portion 16. The water meter 200 is provided with a mortise and tenon as the second clamping portion 230. Besides, the other technical features of the second embodiment are same to those of the first embodiment, and they can produce same effect.

1. A monitoring device of water meter, comprising:
a body for being mounted on a water meter;
a sensor disposed in the body and used for sensing rotation times of a metal sheet of the water meter so as to indirectly obtain the rotation times of a pointer of the water meter to further obtain a pointer rotation times information;
a camera module disposed in the body and used for capturing an image of a number display wheel of the water meter so as to obtain a reading image information;
a communication module disposed in the body and used for connecting with a communication module of another monitoring device of water meter and/or a server; and
a microcontroller unit disposed in the body and electrically connected with the sensor, the camera module and the communication module, the sensor transmitting the pointer rotation times information to the microcontroller unit, the camera module transmitting the reading image information to the microcontroller unit, the microcontroller unit transmitting the received pointer rotation times information and the reading image information to the communication module, the communication module transmitting the received pointer rotation times information containing an identifier and the reading image information to the communication module of another monitoring device of water meter and/or the server, the server comprising a water meter data management unit and an image identifying unit, the water meter data management unit calculating degree of water consumption in accordance with the pointer rotation times information, the image identifying unit calculating water consumption in accordance with the reading image information, and the server selecting at least one of the pointer rotation times information and the reading image information as a basis for calculating degree of water consumption for each water meter.

2. The monitoring device of water meter according to claim 1, wherein the body is provided with at least one lens hole and at least one flashlight hole, the camera module comprises at least one lens and at least one flashlight, the at least one lens faces the at least one lens hole, and the at least one flashlight faces the at least one flashlight hole.

3. The monitoring device of water meter according to claim 2, wherein the body comprises an annular wall with a fogged surface and a transparent window from which a user can visually observe the number display wheel of the water meter; the annular wall is non-opaque; the body comprises a shield body slidably disposed on the body and movable between an open position and a closed position; when the shield body is at the closed position, the shield body completely shields the annular wall; and when the shield body is at the open position, the shield body does not shield the annular wall.

4. The monitoring device of water meter according to claim 1, wherein the communication module comprises a wireless communication unit connected with the server, and the wireless communication unit uses the communication mode of 4G, 5G, a long range wide area network (LoRaWAN), a narrow band interne of things (NB-IoT) or a wireless network.

5. The monitoring device of water meter according to claim 1, wherein the communication module comprises a wireless radio frequency unit having an automatic networking mode and a manual networking mode; wherein when being set in the automatic networking mode, the wireless radio frequency unit is automatically and randomly connected with a wireless radio frequency unit of one of a plurality of monitoring device of water meters; and wherein when being set in the manual networking mode, the wireless radio frequency unit is set to be manually connected with wireless radio frequency unit(s) of at most two monitoring device of water meters closest to the wireless radio frequency unit.

6. The monitoring device of water meter according to claim 1, wherein the body is provided with at least two containing slots, the sensor, the communication module and the microcontroller unit are integrated on a circuit board and disposed in one of the containing slots, the camera module is integrated on another circuit board and deposed in the other containing slot, the monitoring device of water meter further comprises a cover body covering a containing portion for closing the containing slots.

7. The monitoring device of water meter according to claim 1, wherein the body is provided with at least one first clamping portion, the water meter has at least one second clamping portion, and the at least one first clamping portion is detachably clamped on the at least one second clamping portion.

8. The monitoring device of water meter according to claim 1, wherein the body is provided with at least one vent for eliminating mist on a surface of a display unit of the water meter.

9. The monitoring device of water meter according to claim 1, further comprising a battery deposed in the body and electrically connected with the microcontroller unit, wherein the microcontroller unit has a standby mode and an turn-on mode; wherein when the sensor senses that the metal sheet of the water meter stops rotation, the microcontroller unit receives no pointer rotation times information and switches into the standby mode, and the microcontroller unit further controls the camera module and the communication module to stop operation; and wherein when the sensor senses that the metal sheet of the water meter starts rotation, the microcontroller unit is immediately wakened after receiving the pointer rotation times information and switches into the turn-on mode, and the microcontroller unit further controls the camera module and the communication module to start operation.

10. The monitoring device of water meter according to claim 1, wherein after calculating the degree of water consumption in accordance with the pointer rotation times information and the reading image information, the server compares the pointer rotation times information and the reading image information of each water meter, and if an error between the degree of water consumption calculated in accordance with the pointer rotation times information and that calculated in accordance with the reading image information of each water meter is greater than 1%, the server transmits a warning signal to a manager of the server.
